(19) United States
(12) Patent Application Publication
(10) Pub. No.: US 2014/0159531 A1
(43) Pub. Date: Jun. 12, 2014

(54) DRIVE MOTOR OF ECO-FRIENDLY VEHICLE AND ROTOR STRUCTURE OF THE DRIVE MOTOR

(71) Applicants: KIA MOTORS CORPORATION, Seoul (KR); HYUNDAI MOTOR COMPANY, Seoul (KR)

(72) Inventors: Hyoungjun Cho, Seoul (KR); Sanghoon Moon, Seonganam (KR); Kyoungbum Kim, Seongnam (KR); Jung Shik Kim, Seoul (KR)

(73) Assignees: KIA MOTORS CORPORATION, Seoul (KR); HYUNDAI MOTOR COMPANY, Seoul (KR)

(21) Appl. No.: 14/057,255

(22) Filed: Oct. 18, 2013

(30) Foreign Application Priority Data
Dec. 12, 2012 (KR) 10-2012-0144843

(51) Int. Cl. H02K 1/27

(52) U.S. Cl. CPC H02K 1/274
USPC 310/156.48

(57) ABSTRACT

A drive motor that is used as a power source of an eco-friendly vehicle and a rotor structure of the drive motor, wherein the drive motor includes a rotor that has a rotation axis and a plurality of permanent magnets embedded within a rotor core. Each of the permanent magnets are divided into an even number of divided magnets. In addition, the drive motor includes a stator that has a plurality of cores in which teeth for winding coils are formed and a plurality of slots that are interposed among the plurality of cores. An electric steel sheet is filled between the divided magnets of each of the permanent magnets of the rotor.

### CROSS-REFERENCE TO RELATED APPLICATION

This application claims priority to and the benefit of Korean Patent Application No. 10-2012-0144843 filed in the Korean Intellectual Property Office on Dec. 12, 2012, the entire contents of which are incorporated herein by reference.

### BACKGROUND

(a) Field of the Invention

The present invention relates to a drive motor used as a power source of an eco-friendly vehicle and a rotor structure of the drive motor.

(b) Description of the Related Art

As is well known, an eco-friendly vehicle is capable of improving fuel efficiency, satisfying an on board diagnosis (OBD) regulation for exhaust gases, and minimizing a use of fossil fuel. Eco-friendly vehicles include hybrid electric vehicles, fuel cell vehicles, and electric vehicles and use a drive motor as a power source.

The hybrid electric vehicles are recognized as a representative eco-friendly vehicle. The hybrid electric vehicles use an internal combustion engine and a battery power supply. That is, hybrid electric vehicles use an efficient combination of power of the internal combustion engine and power of the drive motor. A hybrid electric vehicle may include, for example, as shown in FIG. 1, an engine 10, a drive motor 20, an engine clutch 30 that interrupts power between the engine 10 and the drive motor 20, a transmission 40, a differential gear 50, a battery 60, an integrated starter-generator 70 that starts the engine 10 or generates power by torque of the engine 10, and wheels 80.

In addition, the hybrid electric vehicle may include a hybrid control unit (HCU) 200 that executes an entire operation of the hybrid electric vehicle, an engine control unit (ECU) 110 that executes an operation of the engine 10, a motor control unit (MCU) 120 that executes an operation of the drive motor 20, a transmission control unit (TCU) 140 that executes an operation of the transmission 40, and a battery control unit (B CU) 160 that manages the battery 60.

The BCU 160 may be referred to as a battery management system (BMS). The integrated starter-generator 70 may be referred to as an integrated starter and generator (ISG) or a hybrid starter and generator (HSG).

The above-described hybrid electric vehicle may be driven in various travel modes such as an electric vehicle (EV) mode that is a pure hybrid vehicle mode in which only the power of the drive motor 20 is used, a hybrid electric vehicle (HEV) mode in which torque of the engine 10 is used as main power and torque of the drive motor 20 is used as auxiliary power, and a regenerative braking (RB) mode in which brake and inertia energy is collected by power generation of the drive motor 20 to be charged in the battery 60 when a vehicle is stopped or travels by inertia.

As described above, the drive motor 20 plays a central role in the hybrid electric vehicle. The drive motor used in the eco-friendly vehicle including the hybrid electric vehicle requires high performance, high power, high reliability, and high durability. In order to satisfy the high performance, high power, the high reliability, and the high durability, the drive motor of the eco-friendly vehicle is researched and developed in various structures.

The above information disclosed in this section is only for enhancement of understanding of the background of the invention and therefore it may contain information that does not form the prior art that is already known in this country to a person of ordinary skill in the art.

### SUMMARY

Therefore, the present invention provides a drive motor of an eco-friendly vehicle and a rotor structure of the drive motor, in which each of permanent magnets embedded within a core of a rotor of the drive motor used as a power source of the eco-friendly vehicle is divided into two and an electric steel sheet (e.g., a rotor core) is filled in a divided space (e.g., about 0.5 to 0.7 mm) to improve temperature durability of the drive motor and prevent a torque from being deteriorated by demagnetization.

According to an exemplary embodiment of the present invention, a drive motor used as a power source of an eco-friendly vehicle, may include a rotor that has a rotation axis and a plurality of permanent magnets embedded within a rotor core and each divided into even divided magnets and a stator that has a plurality of cores in which teeth for winding coils are formed and slots interposed among the plurality of cores. An electric steel sheet may be filled between the divided magnets of each of the permanent magnets of the rotor.

The electric steel sheet may be the rotor core. A distance between the divided magnets of each of the permanent magnets of the rotor may be about 0.5 to 0.7 mm Each of the plurality of permanent magnets may be formed of two divided magnets. A pitch between the permanent magnets of the rotor may be smaller than the pitch between the cores of the stator.

In addition, a rotor structure of a drive motor of an eco-friendly vehicle is provided. The rotor structure may include a rotor that has a rotation axis and a plurality of permanent magnets embedded within a rotor core and a stator that has a plurality of cores in which teeth for winding coils are formed and slots interposed among the plurality of cores. Each of the plurality of permanent magnets may be divided into even divided magnets. A gap between the divided magnets may be filled with an electric steel sheet.

As described above, according to the exemplary embodiment of the present invention, each of the permanent magnets embedded within the core of the rotor of the drive motor used as the power source of the eco-friendly vehicle may be divided into two and the electric steel sheet (e.g., the rotor core) may be filled in the divided space (e.g., about 0.5 to 0.7 mm) to improve temperature durability of the drive motor and to prevent a torque from being deteriorated by demagnetization.

### BRIEF DESCRIPTION OF THE DRAWINGS

FIG. 1 is an exemplary block diagram of a hybrid electric vehicle that is an eco-friendly vehicle according to the related art;

FIG. 2 is an exemplary sectional block diagram of a drive motor of an eco-friendly vehicle according to an exemplary embodiment of the present invention;

FIG. 3 is an exemplary block diagram of a conceptually extracted main part of a drive motor of an eco-friendly vehicle according to an exemplary embodiment of the present invention; and

FIG. 4 is an exemplary sectional view taken along the line A-A of FIG. 3 according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, fuel cell vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. However, the present invention is not limited to the exemplary embodiment described hereinafter but may be specified in different forms.

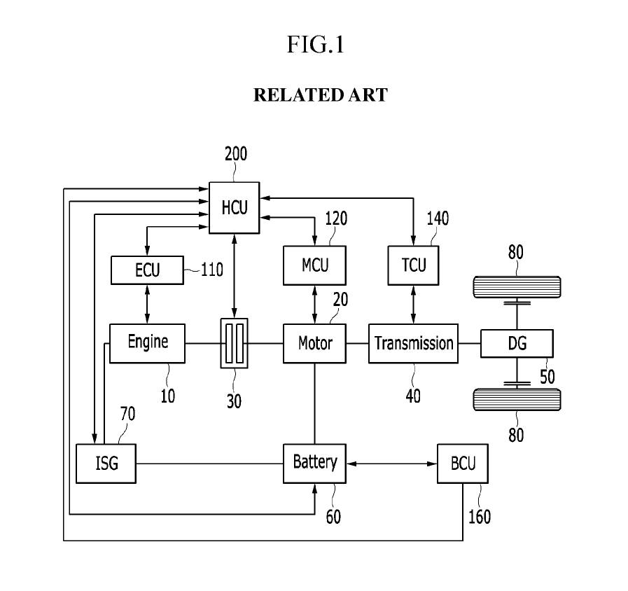

FIG. 1 is an exemplary view schematically showing a hybrid electric vehicle that is an eco-friendly vehicle to which a drive motor according to an exemplary embodiment of the present invention is applied. As shown in FIG. 1, a hybrid electric vehicle to which a drive motor according to an exemplary embodiment of the present invention is applied may include an engine 10, a motor 20, an engine clutch 30 that interrupts power between the engine 10 and the drive motor 20, a transmission 40, a differential gear 50, a battery 60, and an integrated starter-generator 70 that starts the engine 10 or generates power by an output of the engine 10.

In addition, the hybrid electric vehicle to which the drive motor according to the exemplary embodiment of the present invention is applied may include a hybrid control unit (HCU) 200 configured to operate the hybrid electric vehicle, an engine control unit (ECU) 110 configured to operate the engine 10, a motor control unit (MCU) 120 configured to operate the drive motor 20, a transmission control unit (TCU) 140 configured to operate the transmission 40, and a battery control unit (BCU) 160 configured to manage the battery 60.

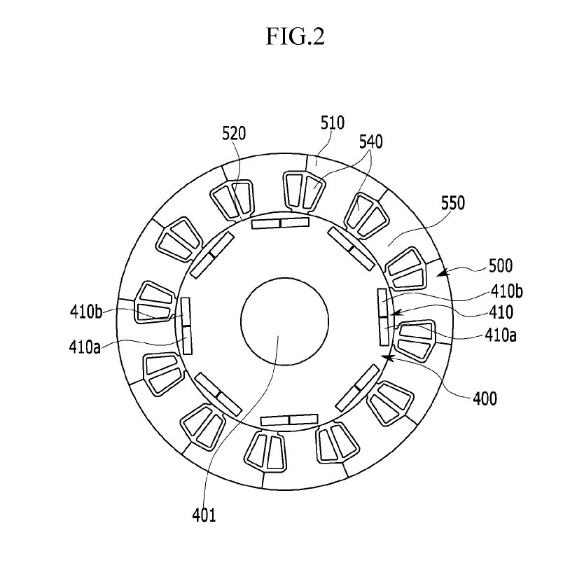

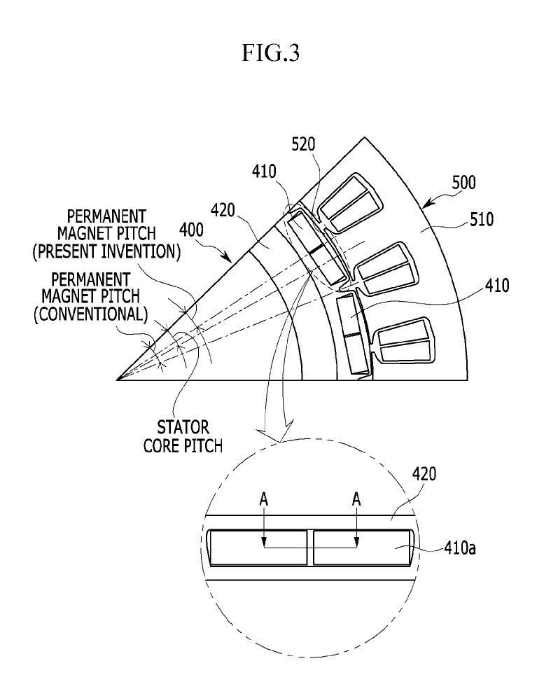

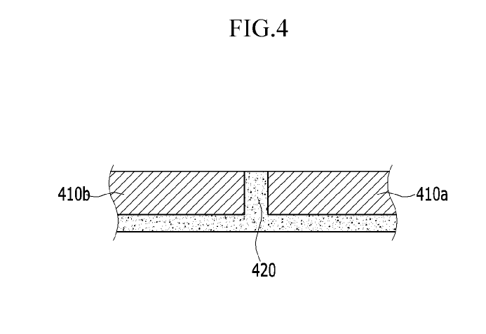

FIG. 2 is an exemplary sectional block diagram showing a drive motor according to an exemplary embodiment of the present invention. FIG. 3 is an exemplary block diagram showing a conceptually extracted main part of a drive motor according to an exemplary embodiment of the present invention. FIG. 4 is an exemplary sectional view taken along the line A-A of FIG. 3.

A rotor 400 of a drive motor according to an exemplary embodiment of the present invention may include a rotation axis 401 and a plurality of permanent magnets 410 embedded within a rotor core 420 and each divided into even (e.g., two) divided magnets 410a and 410b. A stator 500 of a drive motor may include a plurality of cores 510 in which teeth 550 for winding coils 540 are formed and may also include a plurality of slots 520 interposed among the plurality of cores 510. An electric steel sheet may be filled between the divided magnets 410a and 410b of each of the permanent magnets 410 of the rotor 400. Referring to FIG. 4, the electric steel sheet may be the rotor core 420.

When the rotor core 420 is filled between the divided magnets 410a and 410b of each of the permanent magnets 410 of the rotor 400, temperature durability of the drive motor may be improved and loss of an eddy current in the permanent magnets may be reduced. A distance between the divided magnets 410a and 410b of each of the permanent magnets 410 of the rotor 400 may be about 0.5 to 0.7 mm When the distance between the divided magnets 410a and 410b of each of the permanent magnets 410 is determined as 0.5 to 0.7 mm, the rotor core 420 may be easily filled between the divided magnets 410a and 410b and a demagnetization characteristic may be enhanced.

Each of the permanent magnets 410 may include the two divided magnets 410a and 410b to reduce a working process of dividing the permanent magnet. On the other hand, as shown in FIG. 3, a pitch between the permanent magnets 410 of the rotor 400 may be smaller than the pitch between the cores 510 of the stator 500. When the pitch between the permanent magnets 410 of the rotor 400 is smaller than the pitch between the cores 510 of the stator 500, durability and an eddy current characteristic of the drive motor may be improved.

According to the exemplary embodiment of the present invention, each of the permanent magnets embedded within the core of the rotor of the drive motor used as the power source of the eco-friendly vehicle may be divided into two and the electric steel sheet (e.g., the rotor core) may be filled in a divided space (e.g., about 0.5 to 0.7 mm) to improve the temperature durability of the drive motor and to prevent a torque from being deteriorated by demagnetization.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

Description of symbols

| | |
|---|---|
| 400: | rotor |
| 410: | permanent magnet |
| 420: | rotor core |
| 500: | stator |
| 510: | stator core |

What is claimed is:

1. A drive motor used as a power source of a vehicle, comprising:
a rotor that includes a rotation axis and a plurality of permanent magnets embedded within a rotor core, wherein the plurality of permanent magnets are divided into an even number of divided magnets; and
a stator that includes:
a plurality of cores in which teeth for winding coils are formed; and
a plurality of slots interposed among the plurality of cores,
wherein an electric steel sheet is filled between the divided magnets of each of the permanent magnets of the rotor.

2. The drive motor of claim 1, wherein the electric steel sheet is the rotor core.

3. The drive motor of claim 1, wherein each of the plurality of permanent magnets is formed of two divided magnets.

4. The drive motor of claim 1, wherein a pitch between the permanent magnets of the rotor is smaller than the pitch between the cores of the stator.

5. The driver motor of claim 1, wherein a distance between the divided magnets of each of the permanent magnets is about 0.5 to 0.7 mm

6. A rotor structure of a drive motor comprising:
a rotor that includes a rotation axis and a plurality of permanent magnets embedded within a rotor core; and
a stator that includes:
a plurality of cores in which teeth for winding coils are formed; and
a plurality of slots interposed among the plurality of cores,
wherein each of the plurality of permanent magnets is divided into an even number of divided magnets, and
wherein a gap between the divided magnets is filled with an electric steel sheet.

7. The rotor structure of claim 6, wherein the electric steel sheet is the rotor core.

8. The rotor structure of claim 6, wherein a pitch between the plurality of permanent magnets is smaller than the pitch between the plurality of cores.

9. The rotor structure of claim 6, wherein a distance between the divided magnets of each of the permanent magnets is about 0.5 to 0.7 mm
